(19) United States
(12) Patent Application Publication
(10) Pub. No.: US 2016/0336701 A1
(43) Pub. Date: Nov. 17, 2016

(54) SYSTEM OF UNISEX POWER CORDS

(71) Applicant: Alysha Hopkins, Aiken, SC (US)

(72) Inventor: Alysha Hopkins, Aiken, SC (US)

(21) Appl. No.: 14/709,781

(22) Filed: May 12, 2015

(51) Int. Cl. H01R 25/00

(52) U.S. Cl. CPC H01R 25/00

(57) ABSTRACT

A system of unisex power cords including: a dual prong male power cord, where in the dual prong male power cord includes a first dual prong male connector at a first end and a second dual prong male connector at a second end; a female power cord, wherein the female power cord includes a first female connector at a first end and a second female connector at a second end;

and a three prong male power cord, where in the three prong male power cord includes a first three prong male connector at a first end and a second three prong male connector at a second end.

### BACKGROUND OF THE INVENTION

1. Field of Invention

The present invention relates to a system of unisex power cords that provide a unique system of power cords.

2. Description of Related Art

Power cords are used in various applications to supply AC power to appliances, lights, and other electronic devices. Typically a power cord is plugged into a AC outlet that includes at least two openings to receive two prongs that extend from the end of a power cord. In some instances three prongs are provided that include a grounding prong in addition to a positive and negative prong to receive AC power from the power outlet. Further extension cords are provided that have a female end, where the female end receives the power cord from the electronic or electrical device and the male end is plugged into an AC outlet. A typical extension cord includes a female end and a male end in most applications. Certain applications of extension cords may call for the necessity of two female ends or alternatively two male ends depending on application. As a result, it would be advantageous to have a system that supplied a unisex power cord within a convenient kit for use by an end user.

### SUMMARY OF THE INVENTION

The present invention relates to a system of unisex power cords including: a dual prong male power cord, where in the dual prong male power cord includes a first dual prong male connector at a first end and a second dual prong male connector at a second end; a female power cord, wherein the female power cord includes a first female connector at a first end and a second female connector at a second end; and a three prong male power cord, where in the three prong male power cord includes a first three prong male connector at a first end and a second three prong male connector at a second end.

### BRIEF DESCRIPTION OF DRAWINGS

FIG. 1 displays a system of unisex power cords in accordance with the present invention.

### DETAILED DESCRIPTION

The present invention relates to a system of unisex power cords that provide female prongs and male prongs on a unisex system of power cords. The present system includes a two-prong male-to-male power cord, a three-prong female-to-female power cord and a three-prong male-to-male power cord. Each power cord may be applicable in various situations to provide an extension of power as needed between an electronic device and a wall outlet.

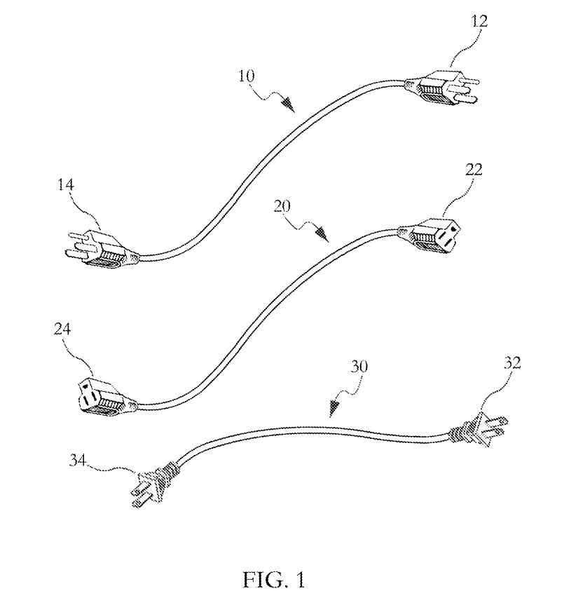

In reference to FIG. 1, a three-prong male-to-male power cord 10 is displayed. The three-prong male-to-male power cord 10 includes a first end 12 and a second end 14. Each end of the power cord 10 has a three-prong male connection that is suitable for use as needed. Further FIG. 1 depicts a female-to-female power cord 20. The power cord 20 includes a first end 22 and a second end 24, where each end includes a female connector. Further FIG. 1 depicts a two-prong male power cord 30 where the power cord 30 includes a two-prong male connector at a first end 32 and a two-prong male connector at a second end 34.

This system in accordance with present invention provides a complete kit of three power cords. The three power cords enable a user to connect appliances or other electronic devices as needed. Further the power cords may be used together where the female may be connected to a three-prong appliance and then used with one of the male-to-male cords. This interchangeability enables a user to have various connections through a series of three unisex power cords. The instant invention has been shown and described in what it considers to be the most practical and preferred embodiments. It is recognized, however, that departures may be made there from within the scope of the invention and that obvious modifications will occur to a person skilled in the art.

1. A system of unisex power cords comprising:
a. a dual prong male power cord, where in the dual prong male power cord includes a first dual prong male connector at a first end and a second dual prong male connector at a second end;
b. a female power cord, wherein the female power cord includes a first female connector at a first end and a second female connector at a second end; and
c. a three prong male power cord, where in the three prong male power cord includes a first three prong male connector at a first end and a second three prong male connector at a second end.

2. The system of unisex power cords according to claim 1, wherein the dual prong male power cord is used with the female power cord.

3. The system of unisex power cords according to claim 1, wherein the three prong male power cord is used with the female power cord.

4. The system of unisex power cords according to claim 1, wherein the dual prong male power cord, the female power cord and three prong male power cord are used together.
